(19) United States
(12) Patent Application Publication
(10) Pub. No.: US 2007/0259318 A1
(43) Pub. Date: Nov. 8, 2007

(54) System for interacting with developmentally challenged individuals

(76) Inventor: Elizabeth V. Harrison, Carbondale, IL (US)

Correspondence Address: BRINKS HOFER GILSON & LIONE, P.O. BOX 10395, CHICAGO, IL, 60610, US

(21) Appl. No.: 11/415,712

(22) Filed: May 2, 2006

(51) Int. Cl. G09B 21/00

(52) U.S. Cl. 434/112; 340/825.19

(57) ABSTRACT

An apparatus for interacting with a developmentally challenged individual is set forth. The apparatus includes a user input device, a visual display, an audio output device, and a processing system. The processing system is connected to control the visual display, the input device, and the audio output device and operates to display one or more photographic images on the visual display based on a mastery level of the developmentally challenged individual. The developmentally challenged individual communicates by selecting one of the a predetermined photographic images from the visual display using the user input device. In response to this selection, the processing system controls the audio output device to play audio vocalizations corresponding to the selected photographic image. As the mastery level of the developmentally challenged individual is increased, the photographic images on the visual display may be presented in a hierarchical manner, in effect increasing the communication vocabulary that is available to the developmentally challenged individual. In one example, the user input device, the visual display, the audio output device, and the processing system are integrated with one another to form a handheld unit.

### BACKGROUND OF THE INVENTION

1. Technical Field

The present invention generally relates to interactive communication devices. More particularly, the present invention relates to a device for interacting with developmentally challenged individuals.

2. Related Art

One of the basic qualities of an average human being is the ability to communicate. Human communication provides a means for the exchange of thoughts, ideas, feelings, and the like, with others. This exchange, in turn, is often necessary to integrate a person into society.

Not all individuals are endowed with the same communication skills or potential for acquiring the skills. Rather, many individuals are born with disabilities that impair their ability to communicate. For example, some individuals may be developmentally challenged by autism spectrum disorder or the like. In other instances, the ability of an individual to communicate may be impaired by a disease, accident, etc. In either instance, however, some manner of facilitating communication with these individuals is needed if they are to experience a respectable quality of life.

Aided modes of augmentative and alternative communication (AAC) are frequently employed to communicate with developmentally disabled individuals, such as those with autism spectrum disorder. Such AAC methods have included the use of computer programs that display abstract symbols for selection by the developmentally disabled individual. Selection of the abstract symbol from the display allows the disabled individual to communicate, albeit in a rather unsophisticated manner.

The existing computer programs used to implement AAC methods are relatively rigid in their structure and are not readily adapted to the needs of a specific developmentally challenged individual. Further, it can be difficult to train the developmentally challenged individual in the use of the existing computer programs. Still further, existing computer programs require the developmentally challenged individual to associate real world items with corresponding abstract representations of those items, which can be a formidable task to many of these individuals.

### SUMMARY

An apparatus for interacting with a developmentally challenged individual is set forth. The apparatus includes a user input device, a visual display, an audio output device, and a processing system. The processing system is connected to control the visual display, the input device, and the audio output device and operates to display one or more photographic images on the visual display based on a mastery level of the developmentally challenged individual. The developmentally challenged individual communicates by selecting one of the a predetermined photographic images from the visual display using the user input device. In response to this selection, the processing system controls the audio output device to play audio vocalizations corresponding to the selected photographic image. As the mastery level of the developmentally challenged individual is increased, the photographic images on the visual display may be presented in a hierarchical manner, in effect increasing the communication vocabulary that is available to the developmentally challenged individual. In one example, the user input device, the visual display, the audio output device, and the processing system are integrated with one another to form a handheld unit.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1A illustrates one manner of implementing an AAC system.

FIG. 1B is a schematic block diagram of some of the components that may be included in the AAC apparatus shown in FIG. 1A.

FIG. 2 shows a number of interrelated operations that may be executed by the system shown in FIGS. 1A and 1B.

FIG. 3 shows a number of interrelated operations that may be executed by the system shown in FIGS. 1A and 1B to facilitate communication with a developmentally challenged individual.

FIGS. 4 through 7 illustrate how the AAC apparatus may operate at various mastery levels.

### DETAILED DESCRIPTION OF THE PREFERRED EMBODIMENTS

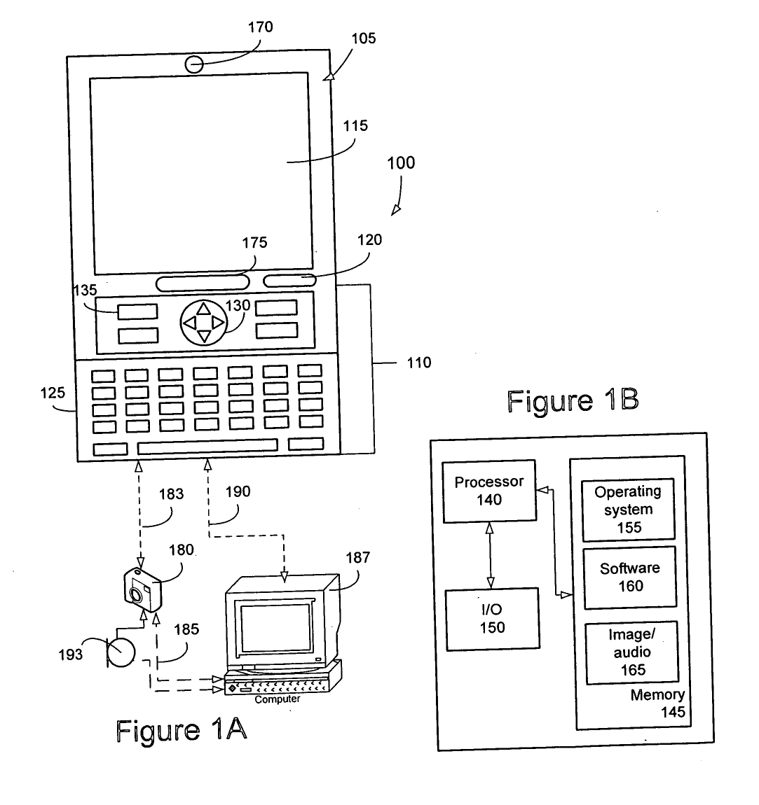

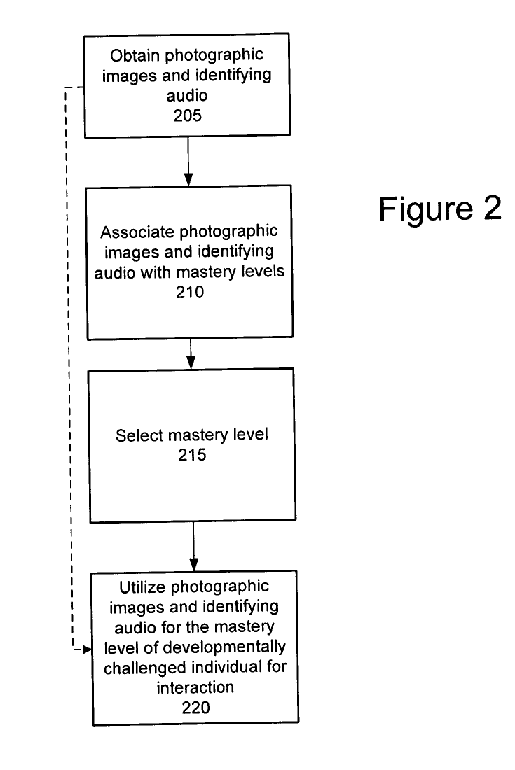

FIG. 1A is a diagram of an exemplary AAC system, generally designated at 100, including an AAC apparatus 105. The AAC apparatus 105 includes a user input device 110, a visual display 115, and an audio output device 120. The user input device 110 may be implemented in a number of different manners. For example, input device 110 may include a keyboard section 125 for entering alphanumeric characters. Additionally, or alternatively, input device 110 may include a mouse-type selection device 130 and/or one or more soft keys 135 to facilitate selection of items on display 115. Still further, visual display 115 may be in the form of a touchscreen display thereby allowing it to function as both a visual display and user input device.

FIG. 1B is a block diagram illustrating some of the basic components that may be included in the AAC apparatus 105. In this example, the AAC apparatus 105 includes a processor 140, memory storage 145, and an I/O interface 150. I/O interface 150 includes the components that allow the processor 140 to interact with the user input device 110, the visual display 115, and the audio output device 120. Memory storage 145 may be implemented using any of a variety of memory technologies. The content of memory storage 145 is accessible by the processor 140 and includes, for example, operating system software 155, AAC software 160, and image/audio storage 165. Both the operating system software 155 and the AAC software 160 constitute software programming that is executable by the processor 140, while image/audio storage 165 may be in the form of a database that includes photographic images and audio files corresponding to the photographic images. One hardware platform that may be used to implement apparatus 105 is the CN30 Mobile Computer System available from Intermec, Inc.

The photographic images and corresponding audio files disposed in image/audio storage 165 are used by the AAC software 160 to interact with a developmentally challenged individual as well as to tailor the type and degree of interaction that the individual has with the AAC apparatus 105. FIG. 1A illustrates a number of different manners that may be used to provide the photographic images and corresponding audio files to the AAC apparatus 105. For example, apparatus 105 may include a built-in camera 170 to capture the desired photographic images for storage and subsequent use. Additionally, apparatus 105 may include a built-in microphone 175 to capture vocalizations that identify the photographic images.

External devices may likewise be used to capture the desired images and audio. For example, a separate camera 180 may be used to capture the images. The images captured by camera 180 may then be transferred to apparatus 105 directly over communication link 183. The images captured by camera 180 alternatively may be transferred over communication link 185 to computer 187 that, in turn, transfers the images to apparatus 105 over communication link 190. Similarly, audio corresponding to the photographic images may be captured using an external microphone 193. Microphone 193, for example, may be integrated with camera 180. Alternatively, microphone 193 may be connected to transfer audio to the computer 187 for further transfer to apparatus 105 over communication link 190. In each of the foregoing examples, the communication links may be implemented as wired links, wireless links, or combinations of each type.

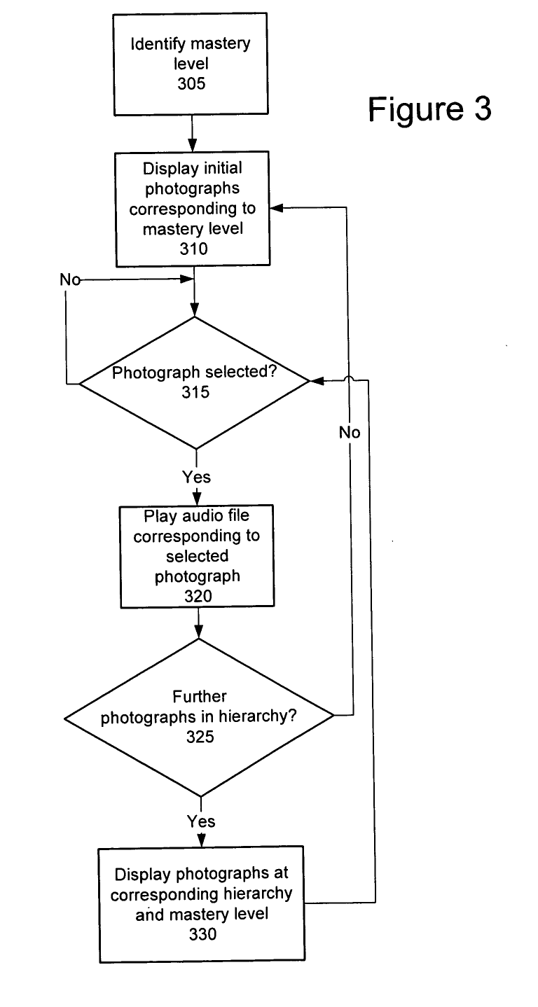

The AAC software 160 may operate in a data entry/setup mode in which the photographic images and corresponding audio vocalization files are entered and stored in the AAC apparatus 105 as well as in a communication mode in which the AAC apparatus 105 is used to interact with the developmentally challenged individual. FIG. 2 illustrates one manner in which the AAC software 160 may operate. In this example, photographic images and identifying audio files are obtained at block 205 during, for example, the data entry mode. The photographic images directly correspond to real items with which the developmentally challenged individual is familiar or is to become familiar. Such images may include photographs of items of clothing (i.e., shirts, shoes, pants, etc.), photographs of toys, photographs of hygienic items (toothbrush, comb, toilet, etc.), and the like. The images may include photographs of a general representation of an item (i.e., a generic shirt). Additionally, or alternatively, the images may include non-generic photographs of specific items found in the environment occupied by the developmentally challenged individual.

For each photograph obtained at block 205, there may be a corresponding audio file that identifies the item displayed in the photograph. The audio file may identify the corresponding photograph using a recorded vocal utterance. For example, a voice recording of the word “shirt” may be associated with a photograph of a shirt. Various degrees of identification may be used, such as “blue shirt” if the corresponding photograph shows a blue shirt, “red shirt” if the corresponding photograph shows a red shirt, etc. The recordings may be made by an individual with whom the developmentally challenged individual is familiar to further tailor the operation of the AAC apparatus 105, although other individuals may provide the desired recordings.

The number of photographic images obtained at block 205 may exceed the number of images that may be properly used by the developmentally challenged individual while communicating using the AAC apparatus 105. Accordingly, the individual entering the photographic images and identifying audio files may limit the number of images based on a mastery level exhibited by the developmentally challenged individual. The mastery level may be determined, for example, by an apparatus administrator, such as an educator, therapist, guardian, or the like. The mastery level may be based on the degree to which the developmentally challenged individual has mastered the use of the AAC apparatus 105 as determined by the apparatus administrator. The mastery level selection process may be executed manually or automatically. In an exemplary manual selection process, the number and arrangement of the images is determined in a manual selection process at block 205 that is executed by the apparatus administrator during the data entry/set up mode. The apparatus administrator effectively limits the number of photographic images by, for example, manually selecting the photographic images that are provided to the apparatus 105 at block 205.

Alternatively, or in addition, the mastery level selection process may be executed in an automatic and/or semi-automatic manner at block 210. For example, photographic images and identifying audio files associated with multiple mastery levels may be obtained at block 205. Each photographic image then may be assigned by the apparatus administrator to a corresponding mastery level through the user interface 110. To this end, thumbnail images corresponding to the photographic images stored in the apparatus may be provided on display 115, where the apparatus administrator may select an image and assign it to the corresponding mastery level. In other implementations, the AAC software may execute an automated prompting routine in which the administrator is prompted for a mastery level as each photographic image, group of photographic images, or thumbnail(s) are presented to the administrator on the display 115. If a hierarchical presentation structure for the photographic images is employed, the administrator may be prompted for the mastery level, the hierarchical level, and an identification of the parent photographic image.

Mastery levels may be presented to and entered by the administrator in a variety of different manners. Numbers and/or alphabetic characters may be used to represent the various mastery levels. Mastery levels designated by number may be easily tracked and understood by the apparatus administrator. For example, a total of M×N mastery levels may be employed where a two-level hierarchical arrangement of photographic images is utilized. In such a system, a maximum of M photographic images are displayed at a first level of the hierarchical arrangement and a maximum of N photographic images are displayed at a second level for each photographic image at the first level. The mastery level, in this instance, corresponds to the total number of photographic images that will be provided to the developmentally challenged individual by the apparatus 105 when the mastery level is set to a particular number.

The apparatus administrator may set the apparatus 105 to operate at a particular mastery level during the data entry and/or setup mode of operation. Entry of the mastery level may be made by the administrator through the user input device 110 at block 215.

As evident from the foregoing discussion, apparatus 105 may be subject to a high degree of customization directed to the targeted developmentally challenged individual. The specific photographs, identifying audio, mastery level, etc., if desired, may constitute customizable parameters that affect the way the apparatus 105 operates. Accordingly, the AAC software 160 may be structured to allow the administrator to enter the data entry and/or set up mode of operation the of the user input device 110 whenever necessary. Apparatus 105 may be protected against inadvertent changes to the customizable parameters by implementing password protection or the like. Such protection may be used to prohibit changes by individuals other than the administrator. Provisions, however, may be included in the AAC software 160 for multiple administrators and, if desired, for multiple developmentally challenged individuals.

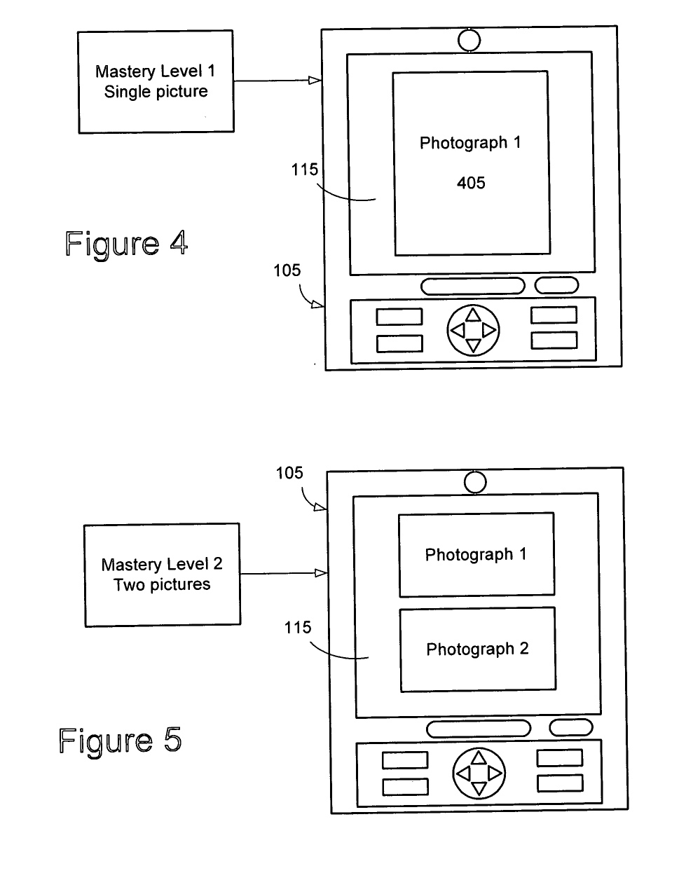

Once the data entry and/or set up processes are completed, the AAC apparatus 105 may enter an interactive mode of operation at block 220. In this mode, the AAC apparatus 105 utilizes the photographic images and identifying audio files for the selected mastery level to facilitate communication between the developmentally challenged individual and other human beings. One manner of implementing this mode in the AAC software 160 is shown in FIG. 3.

In the example shown in FIG. 3, a check is made at block 305 to identify the particular mastery level that is to be used in the interactive mode. The identified mastery level is used at block 310 to select which photographs are initially presented to the developmentally challenged individual on the visual display 115. The developmentally challenged individual may select a photograph as a way to interact with another human being. The developmentally challenged individual selects a photograph through the user input device 110. The user input device 110 may include a touchscreen that is integrated with the visual display 115 thereby allowing the developmentally challenged individual to select a photograph by merely touching the area of the screen on which the photograph is displayed. Alternative manners of selecting a photograph may also be employed, depending on the degree of familiarity and/or expertise that the developmentally challenged individual possesses with respect to the components used to implement AAC apparatus 105. For example, some individuals may prefer to use mouse-like device 134 selection of a photograph. Other individuals may prefer to use soft keys 135 corresponding to the position of the photographs on the visual display 115. The particular manner in which the developmentally challenged individual selects a photograph may be entered as a variable parameter during the data entry and/or set up modes of operation.

At block 315, a check is made to determine whether a photograph has been selected from the visual display 115. When a selection is made, an audio file corresponding to the selected photograph may be played so that it can be heard over speaker 120. As noted above, the audio file may include human vocalizations identifying the subject matter shown in the selected photograph. The subject matter may include items (i.e., clothing, games, etc.), activities (i.e., running, walking, watching TV, etc.), emotions (i.e., happy, sad, angry, etc.), sensations (i.e., hot, cold, pain, pleasure, etc.), and any other subject matter that allows the developmentally challenged individual to communicate with others.

Once a photograph has been selected, a determination is made at step 325 as to whether the selected photograph is part of a hierarchy. If not, control may be returned to either block 310 or block 315. However, if the selected photograph is part of a hierarchy, the photographs at the next hierarchical level are displayed on the visual display 115 at block 330. The photographs displayed at block 330 also may be limited to those that are associated with the current mastery level. With the photographs of the next hierarchical level displayed, control may be returned to block 315 where the developmentally challenged individual is allowed to select a photograph from the photographs provided on visual display 115. The selection process may continue until there are no further photographs for display in the hierarchy. At that point, control may be returned to block 310 where the initial photographs corresponding to the mastery level are provided on visual display 115.

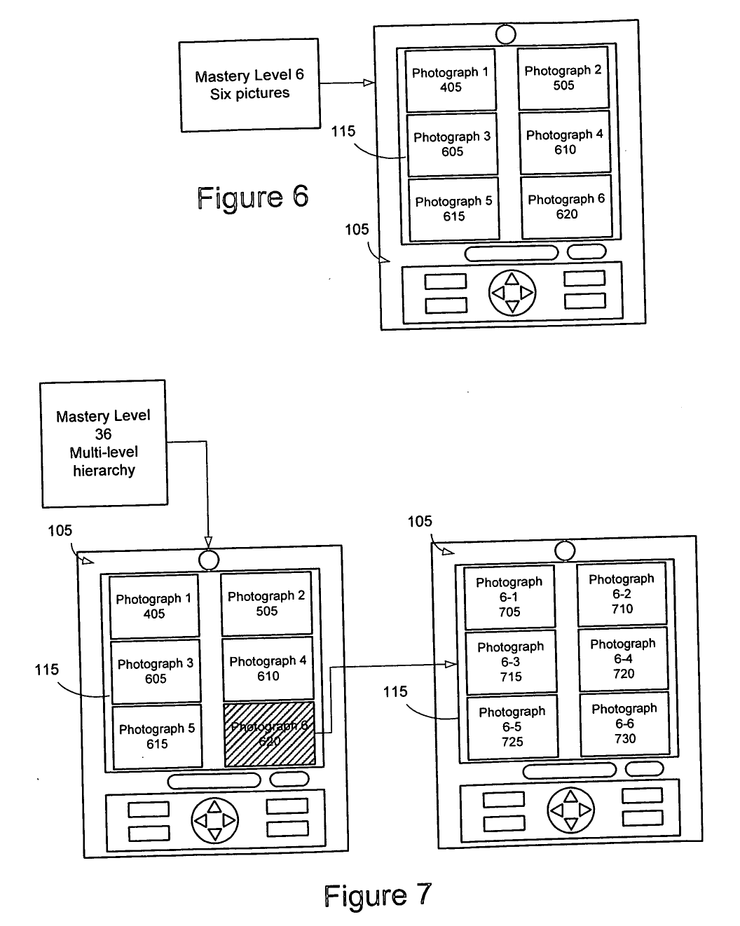

FIGS. 4 through 7 illustrate how the AAC apparatus 105 may operate at various mastery levels. In this example, a total of 36 mastery levels may be entered, and the mastery level corresponds to the number of photographs that are ultimately presented for selection by the developmentally challenged individual. As such, a single photograph 405 is provided for selection on visual display 115 at mastery level 1. In FIG. 5, where the mastery level is set to level 2, two pictures 405 and 505 are provided for selection on visual display 115. FIG. 6 illustrates the presentation of photographs when the mastery level is set to level 6. In this instance, six photographs 405, 505, 605, 610, 615, and 620 are provided for selection on display 115.

FIG. 7 illustrates operation of the AAC apparatus 105 when a multi-level photograph hierarchy is employed. In this example, it is assumed that the mastery level is set to level 36 and that the initial photographs corresponding to this mastery level are represented by the state of the apparatus 105 shown on the left. Accordingly, selection of any of the photographs 405, 505, 605, 610, 615, or 620 will result in presentation of the children photographs associated with the selected photograph in the photograph hierarchy. Selection of photograph 620 by the developmentally challenged individual is illustrated by the cross-hatching in the diagram, although such cross-hatching or other indicia of selection may not necessarily appear during or as a result of the actual selection process. When photograph 620 is selected, the identifying audio file associated with the photograph 620 may be played. Selection of photograph 620 directs the AAC apparatus 105 to the state shown on the right, where the photographs below photograph 620 in the hierarchy are provided on display 115. Here, this next hierarchical level of photographs include photographs 705, 710, 715, 720, 725, and 730.

While various embodiments of the invention have been described, it will be apparent to those of ordinary skill in the art that many more embodiments and implementations are possible within the scope of the invention. For example, there are many embodiments of delay generators and how they may be modulated or bypassed. Accordingly, the invention is not to be restricted except in light of the attached claims and their equivalents.

I claim:

1. An apparatus for interacting with a developmentally challenged individual comprising:
a user input device;
a visual display;
an audio output device;
a processing system connected to control the visual display, the input device, and the audio output device, the processing system operating to display one or more photographic images on the visual display based on a mastery level of the developmentally challenged individual, where the processing system allows the developmentally challenged individual to select a predetermined photographic image using the user input device, and where the processing system controls the audio output device to play audio vocalizations corresponding to the selected photographic image in response to the selection by the developmentally challenged individual.

2. An apparatus as claimed in claim 1, where the user input device, the visual display, the audio output device, and the processing system are integrated with one another to form a handheld unit.

3. An apparatus as claimed in claim 1, where the support device further comprises:
memory for storing photographic images and audio vocalizations;
a camera for acquiring the photographic images; and
a microphone for acquiring audio vocalizations corresponding to the photographic images.

4. An apparatus as claimed in claim 3, where the user input device, the visual display, the audio output device, the processing system, the memory, the camera, and the microphone are integrated with one another to form a handheld unit.

5. An apparatus as claimed in claim 1, where the input device comprises a touchscreen display.

6. An apparatus as claimed in claim 1, where the processing system is operable in a data entry mode in which photographic images and corresponding audio vocalization files are stored in the storage memory.

7. An apparatus as claimed in claim 6, where the mastery level of the developmentally challenged individual may be entered into the processing system during the data entry mode.

8. An apparatus as claimed in claim 7, where the processing system presents the predetermined set of photographic images on the visual display in a hierarchical manner on successive screens when the mastery level of the developmentally challenged individual exceeds a predetermined mastery level.

9. An apparatus for interacting with a developmentally challenged individual comprising:
a processor;
memory storage;
digital photographic images and corresponding digital audio vocalizations stored in the storage memory and accessible by the processor;
a visual display responsive to the processor to display the photographic images;
an audio output device responsive to the processor to play the stored audio vocalizations;
software code executable by the processor to display predetermined photographic images on the visual display based on a mastery level of the developmentally challenged individual; and
an input device allowing the developmentally challenged individual to select a predetermined photographic image on the visual display, where the software code is further executable by the processor to direct the audio output device to play a stored audio vocalization file that corresponds to the selected photographic image.

10. An apparatus as claimed in claim 9, where the processor, the memory storage, the user input device, the visual display, the audio output device, and the software code are integrated with one another to form a handheld unit.

11. An apparatus as claimed in claim 9, where the support device further comprises:
a camera for acquiring the photographic images; and
a microphone for acquiring audio vocalizations corresponding to the photographic images.

12. An apparatus as claimed in claim 11, where the processor, the memory storage, the user input device, the visual display, the audio output device, the camera, the software code, and the microphone are integrated with one another to form a handheld unit.

13. An apparatus as claimed in claim 9, where the input device comprises a touchscreen display.

14. An apparatus as claimed in claim 9, where the software code is executable in a data entry mode in which the photographic images and corresponding audio vocalization files are stored in the storage memory.

15. An apparatus as claimed in claim 14, where the mastery level of the developmentally challenged individual may be entered during the data entry mode.

16. An apparatus for interacting with a developmentally challenged individual comprising:
a user input device;
a visual display;
an audio output device;
a processing system connected to control the visual display, the input device, and the audio device, the processing system operating to display one or more photographic images on the visual display, where the processing system allows the developmentally challenged individual to select a predetermined photographic image using the user input device and controls the audio output device to play audio vocalizations corresponding to the selected photographic image in response to selection by the developmentally challenged individual.

17. A method for interacting with a developmentally challenged individual comprising:
displaying one or more photographic images of real objects on an electronic display;
allowing the developmentally challenged individual to select a photographic image from the electronic display using a user input device;
playing audio vocalizations corresponding to the selected photographic image in response to the selection by the developmentally challenged individual.

18. A method as claimed in claim 17, and further comprising selecting the one or more photographic images for display based on a mastery level of the developmentally challenged individual.

19. A method as claimed in claim 17, where the developmentally challenged individual selects the photographic image from the electronic display using a touchscreen on which the photographic image is displayed.

20. A method as claimed in claim 17, where the displayed photographic images of real objects correspond to personal artifacts of the developmentally challenged individual.
